(19) United States
(12) Patent Application Publication
(10) Pub. No.: US 2026/0149330 A1
(43) Pub. Date: May 28, 2026

(54) ELECTRICAL APPARATUS

(71) Applicant: TOYOTA JIDOSHA KABUSHIKI KAISHA, Toyota-shi (JP)

(72) Inventor: Takaya NAGAI, Nagoya-shi (JP)

(73) Assignee: TOYOTA JIDOSHA KABUSHIKI KAISHA, Toyota-shi (JP)

(21) Appl. No.: 19/276,698

(22) Filed: Jul. 22, 2025

(30) Foreign Application Priority Data
Nov. 25, 2024 (JP) 2024-204716

(51) Int. Cl. H02K 5/22; H01B 7/00; H02K 5/08

(52) U.S. Cl. CPC H02K 5/22; H02K 5/08; H01B 7/0045

(57) ABSTRACT

An electrical apparatus (electric motor) disclosed in the present specification includes a housing body provided with an opening, a housing cover configured to close the opening, a wire harness, and a clip. An electrical device, such as a rotor and a stator, is housed in the housing body. The wire harness is along a back surface of the housing cover, the back surface facing the stator. The clip is fixed to the housing and is open toward a back surface of the housing cover. The wire harness passes through the clip. That is, the clip holds the wire harness at a position that is predetermined.

### CROSS-REFERENCE TO RELATED APPLICATION

This application claims priority to Japanese Patent Application No. 2024-204716 filed on Nov. 25, 2024. The disclosure of the above-identified application, including the specification, drawings, and claims, is incorporated by reference herein in its entirety.

### BACKGROUND

### 1. Technical Field

The technique disclosed in the present specification relates to an electrical apparatus, such as an electric motor.

### 2. Description of Related Art

In an electrical apparatus represented by an electric motor, a bracket that holds a wire harness at a predetermined position in a housing is used. A bracket disclosed in Japanese Unexamined Patent Application Publication No. 2024-108011 (JP 2024-108011 A) has a tubular body through which a wire harness passes and a mounting portion that fixes the body to an electrical device inside a housing. In a case where the bracket is used, the wire harness needs to be passed through the body of the bracket and the bracket further needs to be fixed to the electrical device.

### SUMMARY

The bracket in JP 2024-108011 A has a complicated structure, and a mounting process is also complicated. The present specification provides an electrical apparatus in which a wire harness can be held at a predetermined position in a housing of the electrical apparatus with a simple structure and a simple process.

An electrical apparatus disclosed in the present specification includes a housing body provided with an opening, a housing cover configured to close the opening, a wire harness, and a clip. An electrical device is housed in the housing body. The wire harness is provided along a back surface of the housing cover. The clip is fixed to the electrical device and is open toward the back surface of the housing cover. The wire harness passes through the clip. That is, the clip holds the wire harness at a predetermined position.

In the electrical apparatus according to the present specification, when the housing cover is mounted on the housing body, the wire harness is guided to the clip and is held at a predetermined position. When the housing cover is mounted on the housing body, the wire harness is held at the predetermined position. The wire harness can be held at the predetermined position by a simple process. The clip may be open toward the back surface of the housing cover, and has a simple structure. The electrical apparatus disclosed in the present specification can hold the wire harness at the predetermined position in the housing with a simple structure and a simple process.

A typical example of the electrical apparatus is an electric motor. The electrical device housed in the housing body is a stator and a rotor of the electric motor, and the clip is mounted on a coil end cover that is made of resin and that covers a coil end of the stator. The clip may be made of the same resin as the coil end cover.

Details of the technique and further improvements thereof disclosed in the present specification will be described in the following “DETAILED DESCRIPTION OF EMBODIMENTS”.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view and a front view of an electrical apparatus (electric motor) of an embodiment in a coordinate system in the drawing;

FIG. 2 is a side view of a housing cover separated from a housing body;

FIG. 3A is a side view of a variation of the clip;

FIG. 3B is a side view of the variation of the clip;

FIG. 3C is a side view of the variation of the clip; and

FIG. 3D is a side view of the variation of the clip.

### DETAILED DESCRIPTION OF EMBODIMENTS

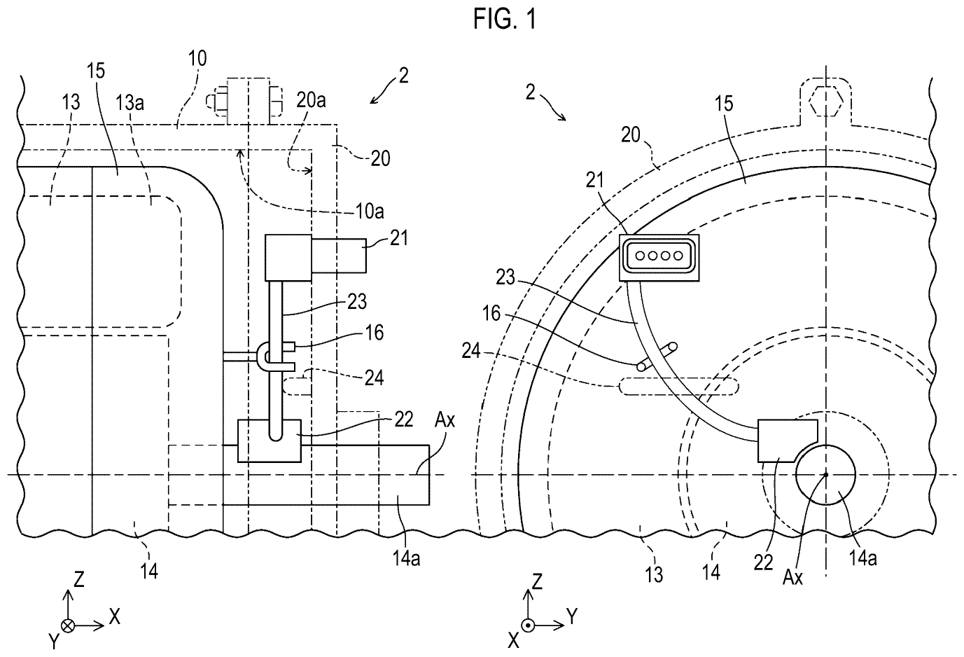

An electrical apparatus according to an embodiment will be described with reference to the drawings. The electrical apparatus of the embodiment is an electric motor 2. In addition, in the following, the “electric motor” is simply referred to as a “motor”. FIG. 1 shows a side view and a front view of the motor 2. A right side of FIG. 1 shows a front view, and a left side of FIG. 1 shows a side view. An axial line Ax of the motor 2 is parallel to the X-axis of the coordinate system in the drawing. In FIG. 1, the motor 2 is cut by a wavy line, and a part of the motor 2 is omitted. In addition, in FIG. 1, a housing body 10 and a housing cover 20 are drawn by a virtual line in order to show the internal structure of the motor 2.

A stator 13 and a rotor 14 of the motor 2 are housed in the housing body 10. The housing body 10 is cylindrical, and an opening 10a is provided at one end of the housing body 10. The housing cover 20 closes the opening 10a. The housing cover 20 is fixed to the housing body 10 with a bolt. A hole is provided at the center of the housing cover 20, and a shaft 14a of the rotor 14 passes through the hole and extends to the outside of the housing cover 20.

A coil end 13a of the stator 13 is covered with a coil end cover 15. The coil end cover 15 faces a back surface 20a of the housing cover 20. A clip 16 is mounted on the coil end cover 15. The coil end cover 15 and the clip 16 are made of the same kind of resin.

The body of the clip 16 has a U-shape, and a tip end of the U-shape faces the back surface 20a of the housing cover 20. In other words, the clip 16 having a U-shape is open toward the back surface 20a of the housing cover 20.

A wire harness 23 passes through an inside of the U-shape of the clip 16. The wire harness 23 is a signal line that connects a rotational speed sensor 22 and a connector 21. The rotational speed sensor 22 measures a rotational speed of the rotor 14. The sensor signal of the rotational speed sensor 22 is transmitted to the connector 21 through the wire harness 23. A part of the connector 21 is exposed to the outside of the housing cover 20, and a cable (not shown) extending from a controller is connected to the connector 21. The sensor signal of the rotational speed sensor 22 is transmitted to the controller through the wire harness 23, the connector 21, and the cable. The electric power may be transmitted from the controller to the rotational speed sensor 22 through the wire harness 23, the connector 21, and the cable.

The rotational speed sensor 22 and the connector 21 are fixed to the housing cover 20. The wire harness 23 extends along a back surface 20a of the housing cover 20.

A rib 24 is provided on the back surface 20a of the housing cover 20, and the wire harness 23 passes through the inside of the U-shape of the clip 16 and is sandwiched between the clip 16 and the rib 24. The wire harness 23 is fixed to a position that is predetermined by being sandwiched between the clip 16 and the rib 24.

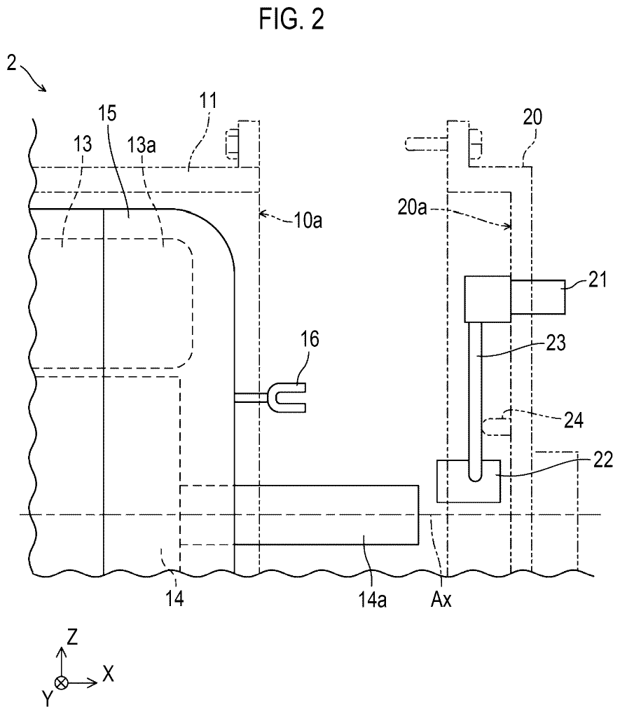

FIG. 2 is a side view of the housing cover 20 separated from the housing body 10. Before the housing cover 20 is assembled to the housing body 10, the wire harness 23 may be shaken because both ends thereof are not fixed. In the motor 2, when the housing cover 20 is mounted on the housing body 10, the wire harness 23 is guided to the clip 16 and is held at a position that is predetermined. When the housing cover 20 is mounted on the housing body 10, the wire harness 23 is held at a position that is predetermined. The clip 16 may be open toward the housing cover 20, and has a simple structure. In particular, the wire harness 23 is firmly fixed by being sandwiched between the rib 24 provided on the back surface 20a of the housing cover 20 and the clip 16. In addition, the wire harness 23 is fixed to the clip 16 at the same time as the housing cover 20 is mounted on the housing body 10. The technique of the embodiment can hold the wire harness at a position that is predetermined in the housing of the motor 2 (electrical apparatus) with a simple structure and a simple process. Here, the inside of the housing means a space surrounded by the housing body 10 and the housing cover 20.

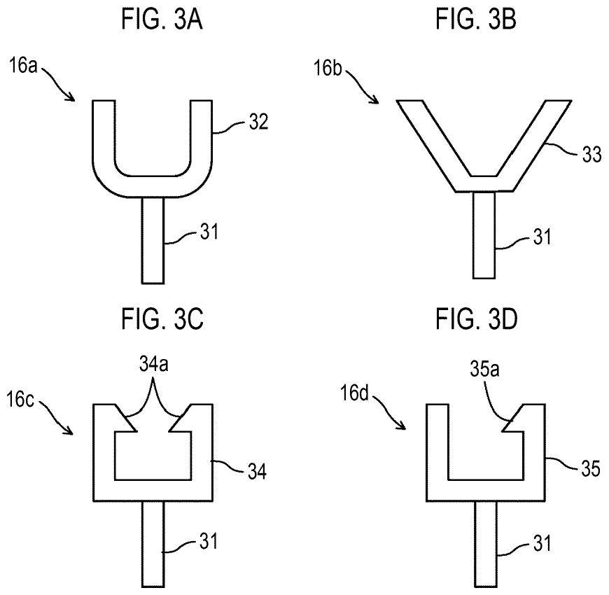

FIGS. 3A to 3D show some variations of the clip 16. The clip 16a in FIG. 3A has the same shape as the clip 16 in FIGS. 1 and 2. The clip 16a has a clip body 32 having a U-shape and a support column 31 that supports the clip body 32. The support column 31 is mounted on an electrical device in the housing body 10. In the case of the embodiment, the support column 31 is mounted on the coil end cover 15 in the housing body 10. The coil end cover 15 is a part of an electrical device. The clip 16a and the coil end cover 15 are made of the same kind of resin. The clip 16a may be formed at the same time as the coil end cover 15 is formed. The clips 16b to 16d to be described later are also the same.

The clip 16b of FIG. 3B has a clip body 33 having a V-shape and a support column 31 that supports the clip body 33. In a case where the clip body 33 having a V-shape is employed, the wire harness 23 is positioned on the narrow bottom of the V-shape.

The clip 16c of FIG. 3C has a clip body 34 having a U-shape and a support column 31 that supports the clip body 34. A locking tab 34a is provided at both tip ends of the clip body 34 having a U-shape. The locking tab 34a protrudes inward of the U-shape. The locking tab 34a restrains the wire harness 23 housed inside the clip body 34 from falling off.

The clip 16d of FIG. 3D has a clip body 35 having a U-shape and a support column 31 that supports the clip body 35. A locking tab 35a is provided at a tip end of one side of the clip body 35 having a U-shape. The locking tab 35a also restrains the wire harness 23 housed inside the clip body 35 from falling off. The clip 16d may be disposed such that the locking tab 35a is positioned on the lower side of the wire harness 23 when the motor 2 is used.

Points to consider regarding the technique described in the embodiments will be described. The electrical apparatus of the embodiment is a motor 2. In the motor 2, the stator 13 and the rotor 14 are housed in the housing body 10. The stator 13 and the rotor 14 are examples of electrical devices housed in the housing body 10 of the electrical apparatus. The technique of the embodiment can be applied to an electrical apparatus other than the motor.

The housing body 10 is cylindrical and has an opening 10a at one end in the axial direction. The housing cover 20 closes the opening 10a. The opening may be provided anywhere in the housing body 10.

One end of the wire harness 23 is connected to the connector 21, and the other end is connected to the rotational speed sensor 22. The connector 21 and the rotational speed sensor 22 are fixed to the housing cover 20. At least one end of the wire harness 23 may be fixed to the housing cover 20. More specifically, at least one end of the wire harness 23 may be fixed to the housing cover 20 or a structure (connector 21) attached to the housing cover 20. The other end of the wire harness 23 may be a connector that can be freely moved or may be fixed to a structure of the housing body 10. The wire harness 23 may be provided along a back surface 20a of the housing cover 20. The wire harness 23 is connected to an electrical apparatus related to an electrical device housed in the housing body 10. The wire harness 23 may be a cable that transmits an electric signal or electric power.

For example, one end of the wire harness may be a temperature sensor fixed to the housing cover 20. The temperature sensor measures an internal temperature of the housing body 10. Alternatively, the temperature sensor measures a temperature of oil circulating in the housing body 10. The other end of the wire harness may extend to the outside from a hole provided in the housing cover 20.

The clip 16 may be disposed so as to support the lower side of the wire harness 23 when the motor 2 is used.

The features of the electrical apparatus (motor 2) described in the embodiment will be listed below.

The clip 16 has a U-shape or a V-shape and is open toward the back surface 20a of the housing cover 20. In other words, the clip 16 has a U-shape or a V-shape, and two tip ends of the clip 16 face the back surface 20a of the housing cover 20.

The clip 16 is fixed to the housing body 10. More specifically, the clip 16 is fixed to an electrical device (for example, a coil end cover 15) housed in the housing body 10. The wire harness 23 is disposed along the back surface 20a of the housing cover 20 and passes through the clip 16.

The wire harness 23 is sandwiched between the structure (rib 24) of the back surface 20a of the housing cover 20 and the clip 16. More specifically, the wire harness 23 is fixed between the structure (rib 24) of the back surface 20a of the housing cover 20 and the clip 16.

The wire harness 23 may be fixed by being sandwiched between the clip 16 and the back surface 20a of the housing cover 20 without including the rib 24.

The clip bodies 34, 35 may have a U-shape or a V-shape, and the locking tabs 34a, 35a for restraining the wire harness 23 from falling off may be provided on at least one of the two tip ends of the clip bodies 34, 35.

The housing body 10 may house other devices (for example, a gear set) in addition to the electrical devices, such as the stator 13 and the rotor 14.

Although specific examples of the aspect of the disclosure have been described above in detail, the examples are merely illustrative and are not intended to limit the scope of the claims. The technology described in the claims includes various modifications and changes of the specific examples exemplified above. The technical elements described in the present specification or the drawings exhibit technical usefulness alone or in various combinations, and are not limited to the combinations described in the claims at the time of filing. Further, the technology exemplified in the present specification or the drawings can achieve a plurality of objectives at the same time, and achieving one of the objectives has technical usefulness.

What is claimed is:

1. An electrical apparatus comprising:
a housing body provided with an opening and in which an electrical device is housed;
a housing cover configured to close the opening;
a wire harness provided along a back surface of the housing cover; and
a clip fixed to the electrical device and open toward the back surface, wherein the wire harness passes through the clip.

2. The electrical apparatus according to claim 1, wherein:
the electrical device is a stator of an electric motor; and
the clip is mounted on a coil end cover that is made of resin and that covers a coil end of the stator.

3. The electrical apparatus according to claim 2, wherein the clip is made of the same resin as the coil end cover.
